(19) United States
(12) Patent Application Publication
(10) Pub. No.: US 2025/0105960 A1
(43) Pub. Date: Mar. 27, 2025

(54) METHOD FOR DETERMINING TRANSPORT BLOCK SIZE, AND DEVICE

(71) Applicant: GUANGDONG OPPO MOBILE TELECOMMUNICATIONS CORP., LTD., Dongguan (CN)

(72) Inventors: Jing XU, Dongguan (CN); Yanan LIN, Dongguan (CN)

(21) Appl. No.: 18/973,519

(22) Filed: Dec. 9, 2024

Related U.S. Application Data
(63) Continuation of application No. PCT/CN2022/119733, filed on Sep. 19, 2022.

(51) Int. Cl. H04L 5/00; H04W 72/0453; H04W 72/11; H04W 72/51

(52) U.S. Cl. CPC H04L 5/0044; H04W 72/0453; H04W 72/11; H04W 72/51

(57) ABSTRACT

Provided is a method for determining a transport block size. The methods is applicable to a network device, a terminal device, or a network device and a terminal device. The method includes: determining the transport block size based on a number of target resource blocks, wherein the number of target resource blocks is determined based on a number of first resource blocks and a number of second resource blocks, wherein the number of first resource blocks is a number of resource blocks configured for a data channel, and the number of second resource blocks includes a number of resource blocks belonging to a first frequency domain resource in the number of first resource blocks.

### CROSS-REFERENCE TO RELATED APPLICATION

This application is a continuation application of international application No. PCT/CN2022/119733, filed on Sep. 19, 2022, the entire contents of which are incorporated herein by reference.

### TECHNICAL FIELD

Embodiments of the present disclosure relate to the technical field of communications, and in particular, relate to a method and apparatus for determining a transport block (TB) size (TBS), and a device and a storage medium thereof.

### BACKGROUND

In data transmission, generally a TBS needs to be determined.

### SUMMARY

Embodiments of the present disclosure provide a method and apparatus for determining a TBS, and a device and a storage medium thereof. The technical solutions are as follows.

According to some embodiments of the present disclosure, a method for determining a TBS is provided. The method is applicable to at least one of a network device or a terminal device, and includes:
determining the TBS based on a number of target resource blocks, wherein
the number of target resource blocks is determined based on a number of first resource blocks and a number of second resource blocks,
wherein the number of first resource blocks is a number of resource blocks configured for a data channel, and the number of second resource blocks includes a number of resource blocks belonging to a first frequency domain resource in the number of first resource blocks.

According to some embodiments of the present disclosure, a terminal device is provided. The terminal device includes: a processor, a transceiver connected to the processor, and a memory storing one or more executable instructions; wherein the processor, when loading and executing the one or more executable instructions, is caused to perform the method for determining the TBS in the above embodiments.

According to some embodiments of the present disclosure, a network device is provided. The network device includes: a processor, a transceiver connected to the processor, and a memory storing one or more executable instructions; wherein the processor, when loading and executing the one or more executable instructions, is caused to perform the method for determining the TBS in the above embodiments.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic diagram of an X division duplex (XDD) technology in some practices;

FIG. 2 is a schematic diagram of a method for indicating a frequency domain resource in some practices;

FIG. 3 is a schematic diagram of a method for indicating a frequency domain resource in some practices;

FIG. 4 is a schematic diagram of a system for determining a TBS according to some embodiments of the present disclosure;

FIG. 5 is a schematic flowchart of a method for determining a TBS according to some embodiments of the present disclosure;

FIG. 6 is a schematic flowchart of a method for determining a TBS according to some embodiments of the present disclosure;

FIG. 7 is a schematic diagram of a frequency domain resource according to some embodiments of the present disclosure;

FIG. 8 is a schematic diagram of a frequency domain resource according to some embodiments of the present disclosure;

FIG. 9 is a schematic flowchart of a method for determining a TBS according to some embodiments of the present disclosure;

FIG. 10 is a schematic diagram of a method for determining a TBS according to some embodiments of the present disclosure;

FIG. 11 is a schematic diagram of a method for determining a TBS according to some embodiments of the present disclosure;

FIG. 12 is a schematic flowchart of a method for determining a TBS according to some embodiments of the present disclosure;

FIG. 13 is a schematic diagram of a method for determining a TBS according to some embodiments of the present disclosure;

FIG. 14 is a schematic flowchart of a method for determining a TBS according to some embodiments of the present disclosure;

FIG. 15 is a schematic diagram of a method for determining a TBS according to some embodiments of the present disclosure;

FIG. 16 is a schematic flowchart of a method for determining a TBS according to some embodiments of the present disclosure;

FIG. 17 is a schematic diagram of a method for determining a TBS according to some embodiments of the present disclosure;

FIG. 18 is a schematic flowchart of a method for determining a TBS according to some embodiments of the present disclosure;

FIG. 19 is a schematic diagram of a method for determining a TBS according to some embodiments of the present disclosure;

FIG. 20 is a schematic diagram of a method for determining a TBS according to some embodiments of the present disclosure;

FIG. 21 is a schematic flowchart of a method for determining a TBS according to some embodiments of the present disclosure;

FIG. 22 is a schematic diagram of a method for determining a TBS according to some embodiments of the present disclosure;

FIG. 23 is a block diagram of an apparatus for determining a TBS according to some embodiments of the present disclosure; and

FIG. 24 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings. The exemplary embodiments are described in detail herein, and examples are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” and the like may be used herein to describe various pieces of information, such information should not be limited to these terms. These terms are only used to distinguish one type of information from another. For example, a first parameter may also be referred to as a second parameter, and similarly, a second parameter is also referred to as a first parameter, without departing from the scope of the present disclosure. The word “if,” as used herein, may be interpreted as “in the case that,” “in the case of,” or “in response to determining that,” depending on the context.

Some key terms in the present disclosure are described as follows.

### (1) Method for Determining a TBS

Determination of the TBS in the data channel, such as a physical downlink shared channel (PDSCH), a physical uplink shared channel (PUSCH) the like includes the following three processes. Using the PDSCH as an example, the determination of the TBS includes the following processes.
1) A number N_{RE} of resource elements (REs) of the PDSCH is determined, which includes:
i. determining a number of REs in a physical resource block (PRB) by the formular:

$${N}_{R E}^{′} = {N}_{sc}^{R B} \times {N}_{s y m b}^{s h} - {N}_{D M R S}^{P R B} - {N}_{o h}^{P R B} ;$$

wherein N_{sc}^{RB} is equal to 12, and represents a number of subcarriers in a resource block (RB), N_{symb}^{sh} represents a number of symbols occupied by a PDSCH in a slot, N_{DMRS}^{PRB} represents a number of REs occupied by a demodulation reference signal (DMRS) in a PRB, and Nₒₕ^{PRB} represents a number of overhead REs configured in a PRB. The number of overhead REs includes a number of REs occupied by control information of a synchronizing channel, a physical broadcast channel (PBCH), a physical downlink control channel (PDCCH), a physical uplink control channel (PUCCH), and the like; and
ii. determining a number of REs in the PDSCH by the formular: N_{RE}=min(156,N′_{RE})×n_{PRB}, wherein n_{PRB} represents a number of PRBs allocated by the network device to the terminal device.
2) An amount N_{info} of intermediate information carried over the PDSCH is calculated by the formular: N_{info}=N_{RE}×R×Qₘ×ν, wherein N_{RE} represents the calculated number of REs in the PDSCH, R represents a bit rate of data transmission over the PDSCH, Qₘ represents a modulation order of data on the PDSCH, and ν represents a number of transmission layers of the PDSCH.
3) The TBS is determined based on the amount N_{info} of intermediate information, which includes:
i. determining the TBS by quantitative table lookup in the case that N_{info} is less than or equal to 3824; or
ii. determining the TBS by quantitative calculation in the case that N_{info} is greater than 3824.

### (2) Uplink Sub-Band in a Downlink Symbol/Slot

In some practices, data is transmitted and received concurrently on different sub-bands in a same sub-frame, which is referred to as an XDD technology and is mainly applicable to the network device. The terminal device still only transmits or receives data in a sub-frame.

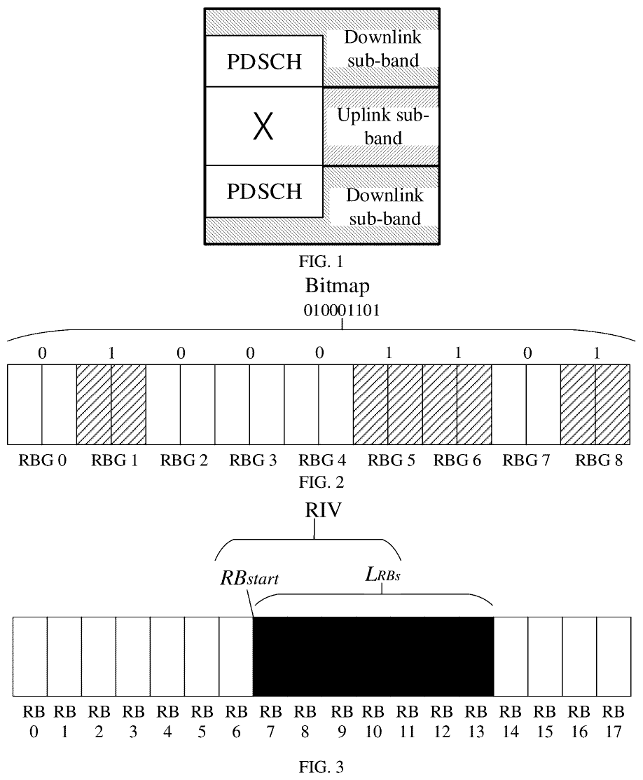

FIG. 1 illustrates the XDD technology. As shown in FIG. 1, an intermediate sub-band of a frequency domain resource corresponding to the downlink symbol/slot is configured as the uplink sub-band. In the case that the terminal device is configured or instructed to receive data in the downlink symbol/slot, for example, receive data carried in the PDSCH, the frequency domain resource occupied by the PDSCH is overlapped with the uplink sub-band of the frequency domain resource corresponding to the downlink symbol/slot. For the resource part of the uplink sub-band, the network device is in a state of receiving uplink data of another terminal device, and thus cannot transmits downlink data to the terminal device in the uplink sub-band. That is, the network device transmits the PDSCH to the terminal device in the downlink sub-bands on two sides of the uplink sub-band.

Sub-band configurations in different symbols/slots in a sub-frame are coincident or different, which are not limited in the embodiments of the present disclosure.

### Method for Indicating a Frequency Domain Resource

The method for indicating the frequency domain resource of the PDSCH or the PUSCH generally includes the following two types.

### Resource Allocation Type 0 (Type 0)

The resources are allocated based on the Type 0. A frequency domain resource information domain, that is, RB allocation information, includes a bitmap for indicating or allocating a resource block group (RBG) of the terminal device. One RBG is a set of contiguous PRBs or a set of contiguous virtual resource blocks (VRBs), and a size of an RBG is determined based on high layer parameters and is generally represented by P. RBGs in different bandwidth parts (BWPs) may be different, and RBG sizes in different frequency domain resource configurations may be different.

For an uplink or downlink BWP i including N_{BWP,i}^{size} RBs, a total number of RBGs is represented by N_{RBG}, which is calculated by N_{RBG}=[(N_{BWP,i}^{size}+(N_{BWP,i}^{size} mod P))÷p].

A number of RBs in a first RBG (that is, a size of a first RBG) is RBG₀^{size}=P−N_{BWP,i}^{start} mod P. In the case that (N_{BHP,i}^{start}+N_{BπP,i}^{size})mod P≥0, a number of RBs in a last RBG is RBGₗₐₛₜ^{size}=(N_{BπP,i}^{start}+N_{BπP,i}^{start})mod P. In the case that (N_{BHP,i}^{start}+N_{BπP,i}^{size})mod P≤0, a number of RBs in a last RBG is RBGₗₐₛₜ^{size}=P, and sizes of other RBGs are P.

The bitmap includes N_{RBG} bits, and each bit represents an RBG. The RBGs are arranged in an ascending order of frequencies, and an index of the BWP starts from a BWP with a lowest frequency. The sequential bits of the RBG bitmap are mapped from RBG 0 to RBG N_{RBG}−1 and from a most significant bit (MSB) to a last/least significant bit (LSB). The RBG allocated to the terminal device and the RBG not allocated to the terminal device are represented by different bit values in the bitmap. In the case that a corresponding bit value of an RBG in the bitmap is a first value, the RBG is an RBG allocated to the terminal device. In the case that a corresponding bit value of an RBG in the bitmap is a second value, the RBG is an RBG not allocated to the terminal device. For example, in the case that an RBG is allocated to the terminal device, a corresponding bit value in the bitmap is 1; and in the case that an RBG is not allocated to the terminal device, a corresponding bit value in the bitmap is 0.

Illustratively, as shown in FIG. 2, the network device performs resource allocation on the RBG 0 to the RBG 8 by the Type 0, and the bitmap is 010001101. That is, corresponding bit values of the RBG 1, the RBG 5, the RBG 6, and the RBG 8 in the bitmap are 1, and corresponding bit values of other RBGs in the bitmap are 0. Thus, the RBG 1, the RBG 5, the RBG 6, and the RBG 8 are allocated to the terminal device.

### Resource Allocation Type 1 (Type 1)

The resources are allocated based on the Type 1. A frequency domain resource information domain, that is, RB allocation information, indicates or allocates a set of contiguous VRBs to the terminal device, and mapping of the VRB and PRB in the set of contiguous VRBs are interwoven or non-interwoven, and the VRBs in the set of contiguous VRBs are in an active BWP.

For the Type 1, the frequency domain resource information domain consists of resource indication values (RIVs), and RIVs are determined based on a start VRB serial number RBₛₜₐᵣₜ and a continuous length L_{RBS} of the allocated RB by the following formulas.

In the case that (L_{RBS}−1)≤[N_{BWP}^{size}/2], RIV=N_{BWP}^{size}×(L_{RBS}−1)+RBₛₜₐᵣₜ.

In the case that (L_{RBS}−1)≥[N_{BWP}^{size}/2], RIV=N_{BWP}^{size}×(N_{BWP}^{size}−L_{RBS}+1)+(N_{BWP}^{size}−1−RBₛₜₐᵣₜ).

1≤L_{RBS}≤(N_{BWP}^{size}−RBₛₜₐᵣₜ).

Illustratively, as shown in FIG. 3, the network device performs resource allocation on the RBs 0 to 17 by the Type 1, and indicates that a start serial number RBₛₜₐᵣₜ of the RB is 7 and a continuous length L_{RBS} of the RB is 7. That is, the RBs 7 to 14 are allocated to the terminal device.

However, the number of resource blocks used in the process of determining the TBS is always greater than the number of resource blocks actually used in the data information transmission between the network device and the terminal device or between the terminal devices, such that the calculated TBS is greater than the TBS actually used in the data transmission, the actual transmission bit rate in the data transmission is further great, the complete TB information cannot be carried in the actual data transmission, and the reliability of data transmission is further affected.

Thus, how to determine the transmission block size closer to the TBS actually used in the data transmission is an urgent problem to be solved.

Thus, embodiments of the present disclosure provide a method for determining TBS, such that the calculated TBS is closer to the TBS actually used in the data transmission, the configured bit rate is closer to the actual bit rate, and the reliability of data transmission is improved.

FIG. 4 is a schematic diagram of a system for determining a TBS according to some embodiments of the present disclosure. The system for determining the TBS includes a network device 410 and a terminal device 420, and/or a terminal device 420 and a terminal device 430, which is not limited in the present disclosure.

The network device in the present disclosure has a wireless communication function, and includes, but is not limited to an evolved Node B (eNB), a radio network controller (RNC), a node B (NB), a base station controller (BSC), a base transceiver station (BTS), a home station (for example, a home evolved Node B or, Home Node B (HNB)), a baseband unit (BBU), an access point (AP), a wireless relay node, a wireless return node, a transmission point (TP), or a transmission and reception point (TRP) in a wireless fidelity (Wi-Fi) system, a next generation Node B (gNB), a TRP, or a TP in a 5th Generation (5G) mobile communication system, one or a set (including a plurality of antenna panels) antenna panels of a station in a 5G system, a network node consisting a gNB or a TP (for example, a baseband unit (BBU), a distributed unit (DU), and the like), a station in a beyond fifth generation (B5G) or a 6th Generation (6G) mobile communication system, a core network (CN), a fronthaul, a backhaul, a radio access network (RAN), a network slice, or a service cell, a primary cell (PCell), a primary secondary cell (PSCell), a special cell (SpCell), a secondary cell (SCell), or a neighbor cell of a terminal device.

The terminal device 420 and/or the terminal device 430 in the present disclosure is also referred to as a user equipment (UE), an access terminal, a subscriber unit, a subscriber station, a rover station, a mobile station, a remote station, a remote terminal, a mobile device, a user terminal, a terminal, a wireless communication device, a user agent, or a user apparatus. The terminal includes, but is not limited to, a handheld devices, wearable devices, in-vehicle devices, Internet of thing (IoT) devices, and the like, such as a mobile phone, a tablet, an e-reader, a laptop, a desktop computer, a television, a game console, a mobile Internet device (MID), an augmented reality (AR) terminal, a virtual reality (VR) terminal, a mixed reality (MR) terminal, a wearable device, a hand shank, an electronic tag, a controller, a wireless terminal in the context of industry control, a wireless terminal in the context of self-driving, a wireless terminal in the context of remote medical, a wireless terminal in the context of smart grid, a wireless terminal in the context of transportation safety, a wireless terminal in the context of smart city, a wireless terminal in the context of smart home, a wireless terminal in the context of remove medical surgery, a cellular phone, a cordless phone, a Session Initiation Protocol (SIP) phone, a wireless local loop (WLL) station, a personal digital assistant (PDA), a TV set-top box (STB), a customer premise equipment (CPE), and the like.

The network device 410 is in communication with the terminal device 420 over an air interface technology, for example, over a Uu interface.

Illustratively, communications between the network device 410 and the terminal device 420 includes two communication scenarios, that is, an uplink communication scenario and a downlink communication scenario. Signals are transmitted to the network device 410 in the uplink communication scenario, and signals are transmitted to the terminal device 420 in the downlink communication scenario.

The terminal device 420 is in communication with the terminal device 430 over an air interface technology, for example, over a Uu interface.

Illustratively, communications between the terminal device 420 and the terminal device 430 includes two communication scenarios, that is, a first sidelink communication scenario and a second sidelink communication scenario. Signals are transmitted to the terminal device 430 in the first sidelink communication scenario, and signals are transmitted to the terminal device 420 in the second sidelink communication scenario.

The terminal device 420 and the terminal device 430 are both within a network coverage and in the same cell, the terminal device 420 and the terminal device 430 are both within a network coverage and in different cells, or the terminal device 420 is within a network coverage and the terminal device 430 is outside the network coverage.

The technical solutions according to the embodiments of the present disclosure are applicable to various communication systems, such as a global system of mobile communication (GSM), a code-division multiple access (CDMA) system, a wideband code-division multiple access (WCDMA) system, a general packet radio service (GPRS) system, a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a wireless local area network (WLAN), a wireless fidelity (Wi-Fi), a cellular IoT system, a cellular passive IoT system, evolution systems of the 5G NR system, and evolution systems of the 6G NR system. In some embodiments of the present disclosure, the “NR” is also referred to as a 5G NR system or a 5G system. The 5G mobile communication system includes a non-standalone (NSA) network and/or a standalone (SA) network.

The technical solutions according to the embodiments of the present disclosure are also applicable to machine-type communications (MTC), a long-term evolution-machine (LTE-M) technology, a device-to-device (D2D) network, a machine-to-machine (M2M) network, an IoT network, or other networks. The IoT network includes, for example, Internet of vehicles. Communication modes in the Internet of vehicles system are collectively referred to as vehicle-to-X (V2X, X represents anything). For example, the V2X includes (vehicle-to-vehicle (V2V) communications, vehicle-to-infrastructure (V2I) communications, vehicle-to-pedestrian (V2P) or vehicle-to-network (V2N) communications, and the like.

The system for determining the TBS according to the embodiments of the present disclosure is applicable to communication scenarios, including, but not limited to at least one of an uplink communication scenario, a downlink communication scenario, or a sidelink communication scenario.

It should be noted that in the present disclosure, the bandwidth used for the downlink channel, the bandwidth configured for the downlink channel, the bandwidth used for downlink transmission, the bandwidth used for downlink data transmission, and the bandwidth occupied by the downlink transmission resources have the same or similar meanings. Similarly, the bandwidth used for the uplink channel, the bandwidth configured for the uplink channel, the bandwidth used for uplink transmission, the bandwidth used for uplink data transmission, and the bandwidth occupied by the uplink transmission resources have the same or similar meanings. Similarly, the bandwidth used for the sidelink channel, the bandwidth configured for the sidelink channel, the bandwidth used for sidelink transmission, the bandwidth used for sidelink data transmission, and the bandwidth occupied by the sidelink transmission resources have the same or similar meanings.

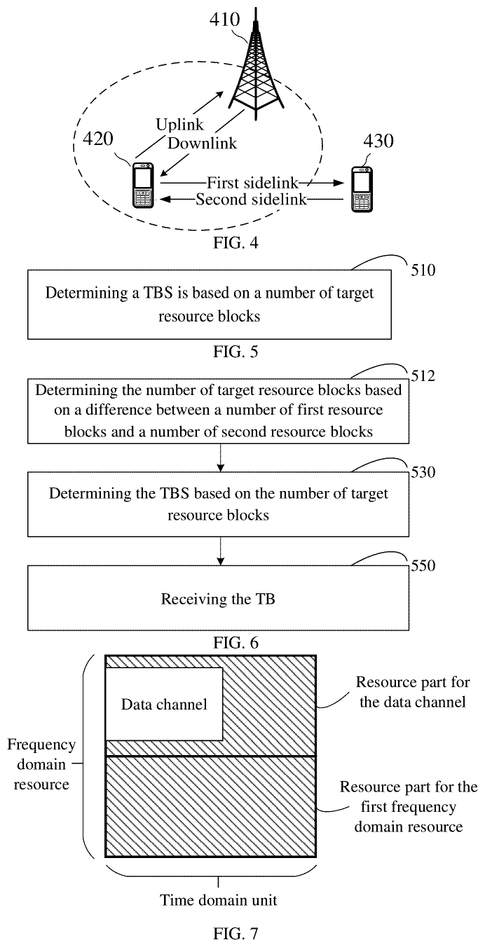

FIG. 5 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S510, a TBS is determined based on a number of target resource blocks.

The number of target resource blocks is determined based on a number of first resource blocks and a number of second resource blocks.

The number of first resource blocks is a number of resource blocks configured for a data channel. The data channel is a downlink data channel (for example, a PDSCH), an uplink channel data channel (for example, a PUSCH), or a sidelink data channel. In some embodiments, the data channel is a data channel used by the terminal, and the configuration is dynamic configuration or semi-persistent configuration with terminal-level granularity.

The number of second resource blocks includes a number of resource blocks belonging to a first frequency domain resource in the number of first resource blocks.

A transmission direction of a frequency domain resource occupied by the data channel is different from a transmission direction of the first frequency domain resource. For example, in the case that the data channel is a downlink data channel, the uplink transmission or the sidelink transmission is performed on the first frequency domain resource; in the case that the data channel is an uplink data channel, the downlink transmission or the sidelink transmission is performed on the first frequency domain resource; or, in the case that the data channel is a first sidelink channel, the uplink transmission, the downlink transmission, or the second sidelink transmission is performed on the first frequency domain resource.

In some embodiments, the method is applicable to a communication scenario supporting the XDD technology, a frequency domain resource for configuring the data channel for the terminal device by the network device includes the first frequency domain resource, and the first frequency domain resource cannot be used to transmit the data channel. In some embodiments, the first frequency domain resource is at least one of an unlink sub-band, a downlink sub-band, a sidelink sub-band, or a guard sideband.

In some embodiments, the number of REs in the data channel is determined based on the number of target resource blocks, the amount of intermediate information carried over the data channel is determined based on the number of REs in the data channel, and the TBS is determined based on the amount of intermediate information carried over the data channel by quantitative table lookup or quantitative calculation.

In summary, in the method according to the present disclosure, the TBS is determined based on the number of target resource blocks. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved.

The number of target resource blocks is determined based on the number of first resource blocks and the number of second resource blocks in the following three types:
Type 1: the number of target resource blocks is determined based on a difference between the number of first resource blocks and the number of second resource blocks;
Type 2: the number of target resource blocks is determined based on the number of first resource blocks and the number of second resource blocks in the first transmission in the repetitive transmissions; and
Type 3: the number of target resource blocks is determined based on the number of first resource blocks and the number of second resource blocks in at least two transmissions in the repetitive transmissions.

### In Type 1: The Number of Target Resource Blocks is Determined Based on a Difference Between the Number of First Resource Blocks and the Number of Second Resource Blocks.

FIG. 6 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S512, the number of target resource blocks is determined based on a difference between the number of first resource blocks and the number of second resource blocks.

The number of first resource blocks is the number of resource blocks configured for the data channel. The data channel is the downlink data channel (for example, a PDSCH), the uplink channel data channel (for example, a PUSCH), or the sidelink data channel.

In some embodiments, the number of first resource blocks is a number of resource blocks dynamically configured for the data channel. For example, the number of first resource blocks is dynamically configured for the terminal device based on downlink control information (DCI).

In some embodiments, the number of first resource blocks is indicated by a frequency domain resource indication domain in a DCI format 1-0, a DCI format 1-1, or a DCI format 1-2.

In some embodiments, the number of first resource blocks is a number of resource blocks semi-persistently configured for the data channel. In some embodiments, the number of first resource blocks is indicated by activating a frequency domain resource indication domain in a DCI format 1-0, a DCI format 1-1, or a DCI format 1-2 in semi-persistent scheduling (SPS).

The number of second resource blocks includes the number of resource blocks belonging to the first frequency domain resource in the number of first resource blocks. The first frequency domain resource cannot be used to transmit the data channel. The transmission direction of the frequency domain resource occupied by the data channel is different from the transmission direction of the first frequency domain resource.

In some embodiments, the first frequency domain resource is configured by the network device.

In some embodiments, the first frequency domain resource is dynamically or semi-persistently configured.

The transmission direction of the frequency domain resource occupied by the data channel being different from the transmission direction of the first frequency domain resource can be understood that the data channel is different from a transmission direction of data in the first frequency domain resource. For example, in the case that the data channel is the downlink data channel, the uplink transmission or the sidelink transmission is performed on the first frequency domain resource; in the case that the data channel is the uplink data channel, the downlink transmission or the sidelink transmission is performed on the first frequency domain resource; or, in the case that the data channel is the first sidelink channel, the uplink transmission, the downlink transmission, or the second sidelink transmission is performed on the first frequency domain resource.

In some embodiments, the first frequency domain resource does not include a guard sideband, or the first frequency domain resource includes a guard sideband.

In some embodiments, the guard sideband is configured by the network device, determined based on a capability of a terminal device, or configured by a network device based on a report capability of a terminal device.

In some embodiments, the terminal device determines the number of target resource blocks based on the difference between the number of first resource blocks and the number of second resource blocks, and determines the guard sideband based on the capability of the terminal device.

In some embodiments, the terminal device determines the number of target resource blocks based on the difference between the number of first resource blocks and the number of second resource blocks, and the network device configures the guard sideband for the terminal device.

In some embodiments, the network device determines the number of target resource blocks based on the difference between the number of first resource blocks and the number of second resource blocks, and configures the guard sideband for the terminal device.

In some embodiments, the network device determines the number of target resource blocks based on the difference between the number of first resource blocks and the number of second resource blocks, and configures the guard sideband for the terminal device based on the report capability of the terminal device.

In some embodiments, the guard sideband is dynamically or semi-persistently configured.

In some embodiments, in the case that the data channel is the downlink data channel, the number of second resource blocks includes the number of resource blocks belonging to the uplink transmission resource in the number of first resource blocks, the number of resource blocks belonging to the uplink transmission resource and the guard sideband in the number of first resource blocks, the number of resource blocks belonging to the sidelink transmission resource in the number of first resource blocks, the number of resource blocks belonging to the sidelink transmission resource and the guard sideband in the number of first resource blocks, the number of resource blocks belonging to the uplink transmission resource and the sidelink transmission resource in the number of first resource blocks, or the number of resource blocks belonging to the uplink transmission resource, the sidelink transmission resource and the guard sideband in the number of first resource blocks.

In some embodiments, in the case that the data channel is the uplink data channel, the number of second resource blocks includes the number of resource blocks belonging to the downlink transmission resource in the number of first resource blocks, the number of resource blocks belonging to the downlink transmission resource and the guard sideband in the number of first resource blocks, the number of resource blocks belonging to the sidelink transmission resource in the number of first resource blocks, the number of resource blocks belonging to the sidelink transmission resource and the guard sideband in the number of first resource blocks, the number of resource blocks belonging to the downlink transmission resource and the sidelink transmission resource in the number of first resource blocks, or the number of resource blocks belonging to the downlink transmission resource, the sidelink transmission resource and the guard sideband in the number of first resource blocks.

In some embodiments, in the case that the data channel is the first sidelink channel, the number of second resource blocks includes the number of resource blocks belonging to the first type resource in the number of first resource blocks or the number of resource blocks belonging to the first type resource and the guard sideband in the number of first resource blocks. The first type resource includes at least one of a second sidelink transmission resource, an uplink transmission resource, or a downlink transmission resource. A transmission direction of the second sidelink transmission resource is different from a transmission direction of a first sidelink transmission resource, and the first sidelink transmission resource is a sidelink resource corresponding to the first sidelink channel.

In some embodiments, the frequency domain resource in the time domain unit of the data channel includes at least one resource part for the data channel and at least one resource part belonging to the first frequency domain resource. The time domain unit is at least one of a frame, a subframe, a slot, a symbol set, or a symbol.

In some embodiments, as shown in FIG. 7, the frequency domain resource in the time domain unit of the data channel includes one resource part for the data channel and one resource part belonging to the first frequency domain resource.

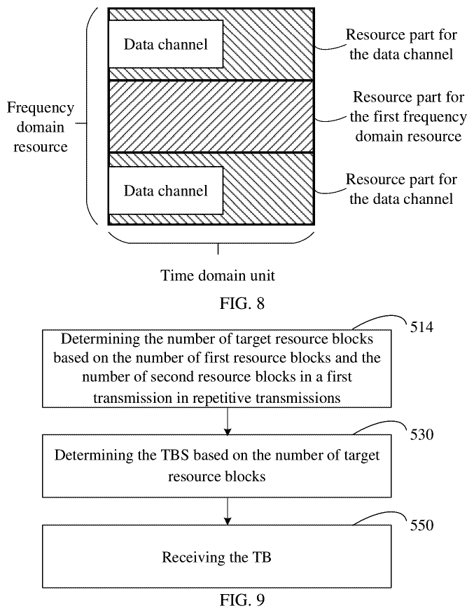

In some embodiments, as shown in FIG. 8, the frequency domain resource in the time domain unit of the data channel includes two resource parts for the data channel and one resource part belonging to the first frequency domain resource.

The number of target resource blocks is determined based on the difference between the number of first resource blocks and the number of second resource blocks. That is, an absolute value of the difference acquired by subtracting the number of first resource blocks from the number of second resource blocks is the number of target resource blocks.

In S530, the TBS is determined based on the number of target resource blocks.

In some embodiments, the number of REs in the data channel is determined based on the number of target resource blocks, the amount of intermediate information carried over the data channel is determined based on the number of REs in the data channel, and the TBS is determined based on the amount of intermediate information carried over the data channel by quantitative table lookup or quantitative calculation.

In some embodiments, the amount of intermediate information carried over the data channel refers to an amount of intermediate information carriable by the data channel, and is not limited to an amount of intermediate information that must be carried over the data channel.

In some embodiments, the TBS is determined based on at least one of a modulation mode of the data channel, a number of transmission layers of the data channel, a bit rate of the data channel, or the number of REs in the data channel.

In some embodiments, the TBS is determined based on the modulation mode of the data channel, the number of transmission layers of the data channel, the bit rate of the data channel, and the number of REs in the data channel.

In some embodiments, the method for determining the TBS based on the number of target resource blocks includes the following processes.
(1) A number N′_{RE} of REs in an RB is calculated using the formula: N′_{RE}=N_{sc}^{RB}×N_{symb}^{sh}−N_{DMRS}^{PRB}−Nₒₕ^{PRB}.

N_{sc}^{RB} is equal to 12, and represents the number of subcarriers in the RB, N_{symb}^{sh} represents the number of symbols occupied by the PDSCH in the slot, N_{DMRS}^{PRB} represents the number of REs occupied by the DMRS in the PRB, and Nₒₕ^{PRB} represents the number of overhead REs configured in the PRB. The number of overhead REs includes the number of REs occupied by control information of the synchronizing channel, the PBCH, the PDCCH, the PUCCH, and the like.
(2) A total number N_{RE} of REs in the data channel is determined based on the number of target resource blocks by the formula: N_{RE}=min(156,N′_{RE})×n_{PRB}.

n_{PRB}=N₃=N₁−N₂, N₃ represents the number of target resource blocks, N₁ represents the number of first resource blocks, and N₂ represents the number of second resource blocks.
(3) An amount N_{info} of intermediate information carried over the data channel is calculated based on the total number N_{RE} of REs in the data channel by the formular: N_{info}=N_{RE}×R×Qₘ×ν.

N_{RE} represents the calculated total number of REs in the data channel, R represents the bit rate of data transmission over the data channel, Qₘ represents the modulation order of data on the data channel, and u represents the number of transmission layers of the data channel.
(4) The TBS is determined based on the amount N_{info} of intermediate information carried over the data channel.

The TBS is determined by quantitative table lookup in the case that N_{info} is less than or equal to 3824.

The TBS is determined by quantitative calculation in the case that N_{info} is greater than 3824.

In some embodiments, the TBS is determined by table lookup or calculation in the protocol in the 3^{rd} Generation Partnership Project (3GPP) (for example, Section 5.1.3.2 of TS 38.214, version 17.2.0).

In S550, the TB is received.

The TBS is the TBS determined based on the number of target resource blocks.

In some embodiments, the frequency domain resource corresponding to the TB in the method according to the embodiments is determined based on at least one of dynamic scheduling or semi-persistent scheduling.

In some embodiments, in the case that the method according to the embodiments is applicable to a scenario where the TB is dynamically scheduled, that is, in the case that the frequency domain resource corresponding to the TB in the embodiments is determined based on dynamic scheduling, the data channel is the downlink data channel, and the frequency domain resource of the downlink data channel is located in a downlink frequency domain resource part, that is, is not located in an uplink frequency domain resource part and/or the guard sideband and/or a sidelink frequency domain resource part.

In some embodiments, in the case that the method according to the embodiments is applicable to a scenario where the TB is dynamically scheduled, that is, in the case that the frequency domain resource corresponding to the TB in the embodiments is determined based on dynamic scheduling, the data channel is the uplink data channel, and the frequency domain resource of the uplink data channel is located in the uplink frequency domain resource part, that is, is not located in the downlink frequency domain resource part and/or the guard sideband and/or the sidelink frequency domain resource part.

In some embodiments, in the case that the method according to the embodiments is applicable to a scenario where the TB is dynamically scheduled, that is, in the case that the frequency domain resource corresponding to the TB in the embodiments is determined based on dynamic scheduling, the data channel is the first sidelink channel, and the frequency domain resource of the first sidelink channel is located in a first sidelink frequency domain resource part, that is, is not located in the uplink frequency domain resource part and/or the downlink frequency domain resource part and/or the guard sideband and/or a second sidelink frequency domain resource part.

In some embodiments, the method according to the embodiments is applicable to a first frequency domain resource indication type and/or a second frequency domain resource indication type. The first frequency domain resource indication type indicates a frequency domain resource corresponding to the TB by the bitmap, and the second frequency domain resource indication type indicates the frequency domain resource corresponding to the TB by a start serial number of the resource block and a continuous length of the resource block. Alternatively, the second frequency domain resource indication type indicates the frequency domain resource corresponding to the TB by the RIV.

In some embodiments, the first frequency domain resource indication type is the Type 0 described above, and the second frequency domain resource indication type is the Type 1 described above.

In some embodiments, in the case that the method according to the embodiments is applicable to the first frequency domain resource indication type or the Type 0, the data channel is the downlink data channel, and the frequency domain resource of the downlink data channel is located in the downlink frequency domain resource part, that is, is not located in the uplink frequency domain resource part and/or the guard sideband and/or the sidelink frequency domain resource part.

In some embodiments, in the case that the method according to the embodiments is applicable to the first frequency domain resource indication type or the Type 0, the data channel is the uplink data channel, and the frequency domain resource of the uplink data channel is located in the uplink frequency domain resource part, that is, is not located in the downlink frequency domain resource part and/or the guard sideband and/or the sidelink frequency domain resource part.

In some embodiments, in the case that the method according to the embodiments is applicable to the first frequency domain resource indication type or the Type 0, the data channel is the first sidelink channel, and the frequency domain resource of the first sidelink channel is located in the first sidelink frequency domain resource part, that is, is not located in the uplink frequency domain resource part and/or the downlink frequency domain resource part and/or the guard sideband and/or the second sidelink frequency domain resource part.

In summary, in the method according to the present disclosure, the TBS is determined based on the number of target resource blocks. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved. In addition, as the number of first resource blocks and the number of second resource blocks are dynamically or semi-persistently configured, the flexibility of data transmission is improved.

### In Type 2: The Number of Target Resource Blocks is Determined Based on the Number of First Resource Blocks and the Number of Second Resource Blocks in the First Transmission in the Repetitive Transmissions.

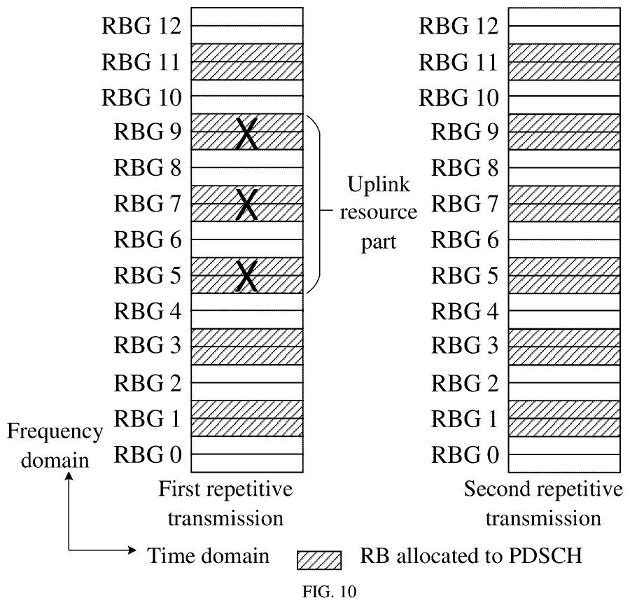

FIG. 9 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S514, the number of target resource blocks is determined based on the number of first resource blocks and the number of second resource blocks in the first transmission in the repetitive transmissions.

The number of target resource blocks is determined based on a difference between the number of first resource blocks and the number of second resource blocks in the first transmission in the repetitive transmissions. That is, an absolute value of the difference acquired by subtracting the number of first resource blocks in the first transmission in the repetitive transmissions from the number of second resource blocks in the first transmission in the repetitive transmissions is the number of target resource blocks.

For detailed description of determining the number of target resource blocks based on the difference between the number of first resource blocks and the number of second resource blocks in the first transmission in the repetitive transmissions, reference may be made to S512 in the above embodiments, which is not described again in the embodiments.

In some embodiments, data in each transmission in the repetitive transmissions is the same. In S530, the TBS is determined based on the number of target resource blocks.

For detailed description of S530, reference may be made to S530 in the above embodiments, which is not described again in the embodiments.

In some embodiments, as shown in FIG. 10, the terminal device 420 receives DCI for scheduling a PDSCH from the network device 410 to indicate that six RBGs are allocated to the PDSCH. The six RBGs are the RBG 1, the RBG 3, the RBG 5, the RBG 7, the RBG 9, and the RBG 11. Assuming that each RBG includes two PRBs, then N₁ is equal to 6 multiplied by 2, that is, 12. In some embodiments, an RBG includes four, six, or eight PRBs, and numbers of PRBs in various RBGs are the same or different. In the first transmission in the repetitive transmissions, three RBGs are in the uplink resource part, N_{2,1} is equal to 3 multiplied by 2, that is, 6. In subsequent m (m is an integer greater than 1) repetitive transmissions, numbers of PRBs in the uplink resource part in the six RBGs are not necessary six in various repetitive transmissions. For example, in the second repetitive transmission, numbers of PRBs in the uplink resource part in the six RBGs are 0, and thus N_{2,2} is equal to 0, and n_{PRB,2} is equal to 12 minus 0, that is, 12, and n_{PRB,1} is equal to 12 minus 6, that is, 6. That is, in the second repetitive transmission, 12 PRBs in the six RBGs are used to carry data on the PDSCH. In the calculation mode, as the first transmission in the repetitive transmissions is generally directly configured by the network device, and the network device greatly controls resources in the first transmission in the repetitive transmissions, the number of target resource blocks is determined based on the number of first resource blocks and the number of second resource blocks in the first repetitive transmission and the configuration of the first frequency domain resource in the time domain unit in the repetitive transmissions, such that the frequency domain resources are accurately and flexibly managed, and the effect desired by the network device is achieved in the repetitive transmissions.

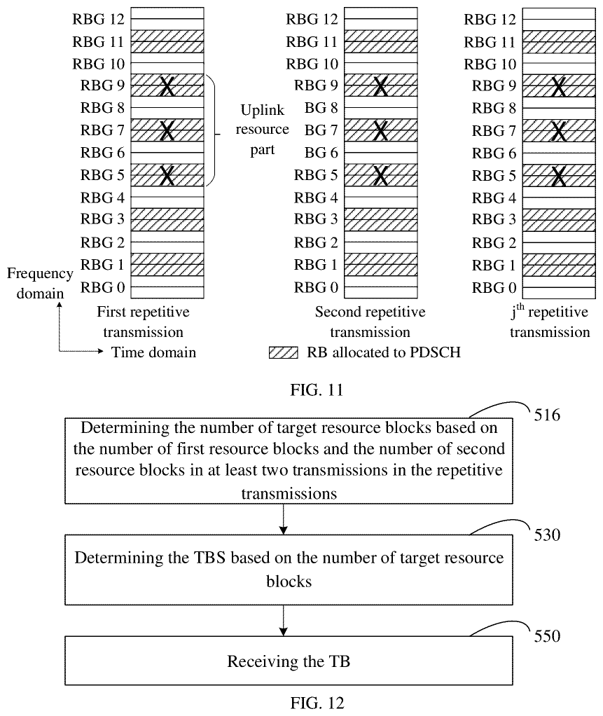

In some embodiments, as shown in FIG. 11, the terminal device 420 receives DCI for scheduling a PDSCH from by the network device 410, which indicates that six RBGs are allocated to the PDSCH. The six RBGs are the RBG 1, the RBG 3, the RBG 5, the RBG 7, the RBG 9, and the RBG 11. Assuming that each RBG includes two PRBs, then N₁ is equal to 6 multiplied by 2, that is, 12. In the first transmission in the repetitive transmissions, three RBGs are in the uplink resource part, N_{2,1} is equal to 3 multiplied by 2, that is, 6, and n_{PRB,1} is equal to 12 minus 6, that is, 6. In subsequent m (m is an integer greater than 1) repetitive transmissions, numbers of PRBs in the uplink resource part in the six RBGs are not necessary six in various repetitive transmissions. For example, in the second repetitive transmission, numbers of PRBs in the uplink resource part in the six RBGs are 0. Then in the j^{th} repetitive transmission, the number of target resource blocks is still determined based on the number of first resource blocks and the number of second resource blocks in the first transmission in the repetitive transmissions, that is, n_{PRB,j}=n_{PRB,1}=6, wherein 1≤j≤m, and j is an integer. In the calculation mode, the TBS in various repetitive transmissions are kept, and the repetition gain is acquired. As the first transmission in the repetitive transmissions is generally directly configured by the network device, and the network device greatly controls resources in the first transmission in the repetitive transmissions, the number of target resource blocks is determined based on the number of first resource blocks and the number of second resource blocks in the first repetitive transmission, such that the effect desired by the network device is achieved in the repetitive transmissions.

In S550, the TB is received.

The TBS is the TBS determined based on the number of target resource blocks.

For detailed description of S550, reference may be made to S550 in the above embodiments, which is not described again in the embodiments.

In summary, in the method according to the present disclosure, the number of target resource blocks is determined based on the number of first resource blocks and the number of second resource blocks in the first transmission in the repetitive transmissions, and the TBS is determined based on the determined number of target resource blocks, such that the TBS in various repetitive transmissions are kept, and the repetition gain is acquired. As the determined number of target resource blocks is closer to the number of target resource blocks actually used in the data transmission, the TBS is closer to the TBS actually used in the data transmission, the configured bit rate is closer to the actual bit rate, and the reliability of data transmission is improved. In addition, as the first transmission in the repetitive transmissions is generally directly configured by the network device, and the network device greatly controls resources in the first transmission in the repetitive transmissions, the method according to the embodiments facilitates achieving the effect desired by the network device in the repetitive transmissions.

### In Type 3: The Number of Target Resource Blocks is Determined Based on the Number of First Resource Blocks and the Number of Second Resource Blocks in at Least Two Transmissions in the Repetitive Transmissions.

FIG. 12 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S516, the number of target resource blocks is determined based on the number of first resource blocks and the number of second resource blocks in at least two transmissions in the repetitive transmissions.

In some embodiments, the number of target resource blocks is a minimum value, a maximum value, an average value, or a middle value of at least two numbers of third resource blocks. The at least two numbers of third resource blocks are determined based on the number of first resource blocks and the number of second resource blocks in the at least two transmissions in the repetitive transmissions.

In some embodiments, the number of third resource blocks in the k^{th} repetitive transmission is determined based on a difference between the number of first resource blocks and the number of second resource blocks in the k^{th} repetitive transmission in the at least two transmissions in the repetitive transmissions. k is a positive integer and is not greater than a total number of repetitive transmissions.

The minimum value, the maximum value, the average value, or the middle value of at least two numbers of third resource blocks in the at least two transmissions in the repetitive transmissions is determined based on the numbers of third resource blocks of the at least two transmissions in the repetitive transmissions.

The number of target resource blocks is determined based on the minimum value, the maximum value, the average value, or the middle value of at least two numbers of third resource blocks in the at least two transmissions in the repetitive transmissions.

In some embodiments, an absolute value of the difference acquired by subtracting the number of first resource blocks from the number of second resource blocks in the k^{th} repetitive transmission in the at least two transmissions in the repetitive transmissions is the number of target resource blocks.

For detailed description of determining the number of third resource blocks in the k^{th} repetitive transmission based on the difference between the number of first resource blocks and the number of second resource blocks in the k^{th} repetitive transmission in the at least two transmissions in the repetitive transmissions, reference may be made to S512 in the above embodiments, which is not described again in the embodiments.

In some embodiments, data in each transmission in the repetitive transmissions is the same.

In S530, the TBS is determined based on the number of target resource blocks.

For detailed description of S530, reference may be made to S530 in the above embodiments, which is not described again in the embodiments.

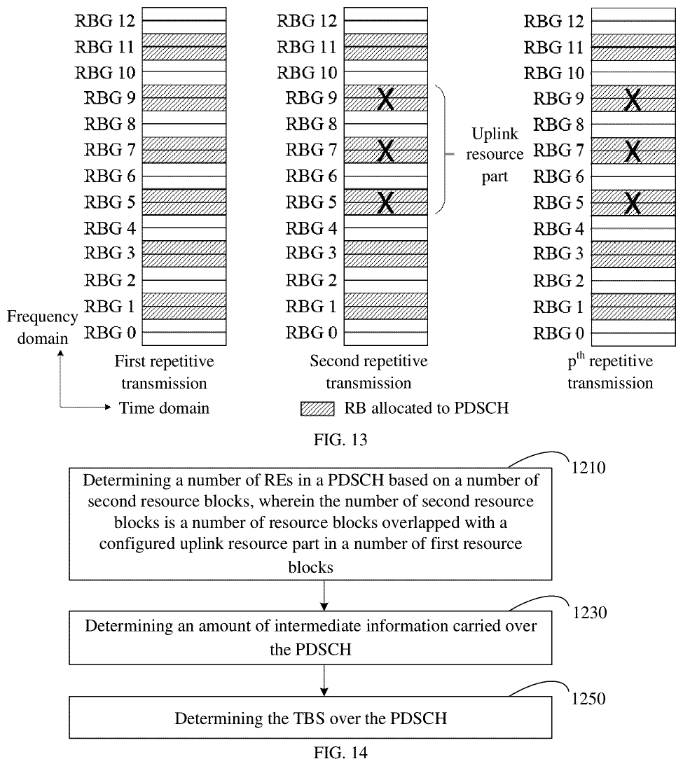

In some embodiments, as shown in FIG. 13, the terminal device 420 receives DCI for scheduling a PDSCH from the network device 410, which indicates that six RBGs are allocated to the PDSCH. The six RBGs are the RBG 1, the RBG 3, the RBG 5, the RBG 7, the RBG 9, and the RBG 11. Assuming that each RBG includes two PRBs, then N₁ is equal to 6 multiplied by 2, that is, 12. In the first transmission in the repetitive transmissions, 0 RBG is in the uplink resource part, N_{2,1} is equal to 0, and n_{PRB,1} is equal to 12 minus 0, that is, 12. In the second repetitive transmission, three RBGs are in the uplink resource part, N_{2,2} is equal to 3 multiplied by 2, that is, 6, and n_{PRB,2} is equal to 12 minus 6, that is, 6. In subsequent m (m is an integer greater than 1) repetitive transmissions, in the p^{th} repetitive transmission, as min {12,6}=6, the number of third resource blocks in the second transmission in the repetitive transmissions is less than the number of third resource blocks in the first transmission in the repetitive transmissions, the number of third resource blocks in the second repetitive transmission is determined as the number of target resource blocks in the p^{th} repetitive transmission, that is, n_{PRB,p}=n_{PRB,2}=6, wherein 2≤p≤m, and p is an integer. In the calculation mode, the TBS is determined based on a minimum number of third resource blocks in at least two transmissions in the repetitive transmissions, and the data transmission can be performed using the same frequency domain resource in various repetitive transmissions, such that data transmission is simplified, and the efficiency of data transmission is improved.

In S550, the TB is received.

The TBS is the TBS determined based on the number of target resource blocks.

For detailed description of S550, reference may be made to S550 in the above embodiments, which is not described again in the embodiments.

In summary, in the method according to the present disclosure, the number of target resource blocks is determined based on the minimum value, the maximum value, the average value, or the middle value of at least two numbers of third resource blocks in the at least two transmissions in the repetitive transmissions, the TBS is determined based on the number of target resource blocks, and the data transmission can be performed using the same frequency domain resource in various repetitive transmissions, such that data transmission is simplified, and the efficiency of data transmission is improved. As the number of target resource blocks determined based on the number of first resource blocks and the number of second resource blocks in at least two transmissions in the repetitive transmissions is closer to the number of target resource blocks actually used in the data transmission, the TBS is closer to the TBS actually used in the data transmission, the configured bit rate is closer to the actual bit rate, and the reliability of data transmission is improved. In addition, as the number of first resource blocks and the number of second resource blocks are dynamically or semi-persistently configured, the flexibility of data transmission is improved.

FIG. 14 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S1210, a number of REs in a PDSCH is determined based on a number of second resource blocks, wherein the number of second resource blocks is a number of resource blocks overlapped with a configured uplink resource part in a number of first resource blocks.

The number of REs in an RB is calculated using the formula N′_{RE}=N_{sc}^{RB}×N_{symb}^{sh}−N_{DMRS}^{PRB}−Nₒₕ^{PRB}. N_{sc}^{RB} is equal to 12, and represents the number of subcarriers in the RB, N_{symb}^{sh} represents the number of symbols occupied by the PDSCH in the slot, n_{DMRS}^{PRB} represents the number of REs occupied by the DMRS in the PRB, and Nₒₕ^{PRB} represents the number of overhead REs configured in the PRB. The number of overhead REs includes the number of REs occupied by control information of the synchronizing channel, the PBCH, the PDCCH, the PUCCH, and the like.

A total number N_{RE} of REs in the PDSCH is determined using the formula N_{RE}=min(156,N′_{RE})×n_{PRB}.

n_{PRB}=N₃=N₁−N₂. N₃ represents the number of target resource blocks, N₁ represents the number of first resource blocks, and N₂ represents the number of second resource blocks.

In some embodiments, the number of first resource blocks is a number of resource blocks in the configured PDSCH, and the number of second resource blocks is the number of resource blocks overlapped with the configured downlink resource part in the number of first resource blocks. That is, the number of second resource blocks is a number of resource blocks in the configured downlink resource part for transmitting the downlink data.

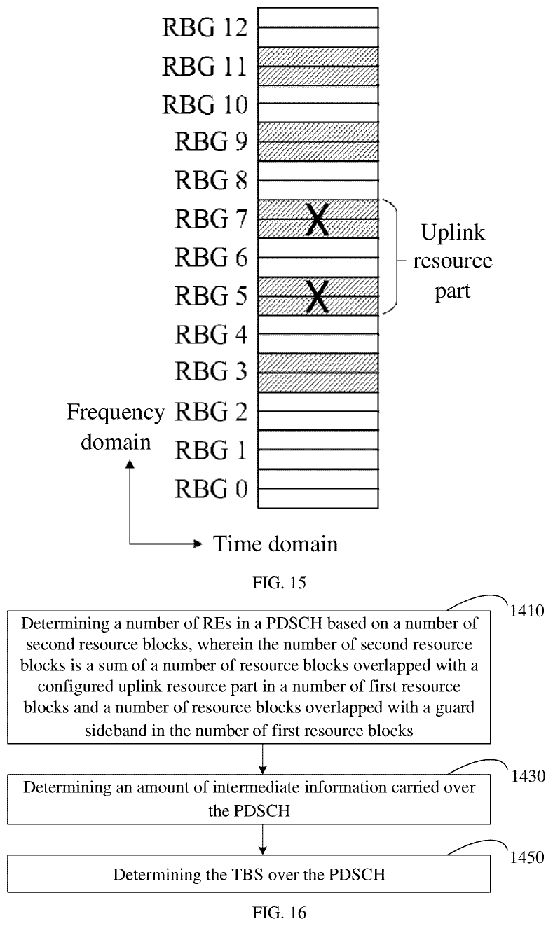

In some embodiments, as shown in FIG. 15, the terminal device 420 receives DCI for scheduling a PDSCH from the network device 410, which indicates that five RBGs are allocated to the PDSCH. The five RBGs are the RBG 3, the RBG 5, the RBG 7, the RBG 9, and the RBG 11. Assuming that each RBG includes two PRBs, then N₁ is equal to 5 multiplied by 2, that is, 10. Two RBGs are in the uplink resource part, N₂ is equal to 2 multiplied by 2, that is, 4, and n_{PRB}=N₃=10−4=6.

In some embodiments, the data channel is the PUSCH, and the number of first resource blocks is a number of resource blocks in the PDSCH configured by the network device, and the number of second resource blocks is the number of resource blocks overlapped with the configured downlink resource part in the number of first resource blocks. That is, the number of second resource blocks is a number of resource blocks in the configured downlink resource part for transmitting the uplink data.

In S1230, an amount of intermediate information carried over the PDSCH is determined.

The amount N_{info} of intermediate information carried over the PDSCH is determined using the formular N_{info}=N_{RE}×R×Qₘ×ν. N_{RE} represents the calculated total number of RES in the PDSCH, R represents the bit rate of data transmission over the PDSCH, Qₘ represents the modulation order of data on the PDSCH, and u represents the number of transmission layers of the PDSCH.

In S1250, the TBS over the PDSCH is determined.

The TBS over the PDSCH is determined based on the amount of intermediate information carried over the PDSCH.

The TBS is determined by quantitative table lookup in the case that N_{info} is less than or equal to 3824.

The TBS is determined by quantitative calculation in the case that N_{info} is greater than 3824.

In some embodiments, the TBS is determined by table lookup or calculation in the protocol in the 3GPP (for example, Section 5.1.3.2 of TS 38.214, version 17.2.0).

In summary, in the method according to the present disclosure, the TBS is determined based on the number of target resource blocks. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved. In addition, the number of second resource blocks is determined based on the uplink resource part, such that the data transmission is performed on the PDSCH using the guard sideband, and the utilization of the frequency domain resource is higher.

FIG. 16 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S1410, a number of REs in a PDSCH is determined based on a number of second resource blocks, wherein the number of second resource blocks is a sum of a number of resource blocks overlapped with a configured uplink resource part in a number of first resource blocks and a number of resource blocks overlapped with a guard sideband in the number of first resource blocks.

The number of REs in an RB is calculated using the formula N′_{RE}=N_{sc}^{RB}×N_{symb}^{sh}−N_{DMRS}^{PRB}−Nₒₕ^{RB}. N_{sc}^{RB} is equal to 12, and represents the number of subcarriers in the RB, N_{symb}^{sh} represents the number of symbols occupied by the PDSCH in the slot, N_{DMRS}^{PRB} represents the number of REs occupied by the DMRS in the PRB, and Nₒₕ^{PRB} represents the number of overhead REs configured in the PRB. The number of overhead REs includes the number of REs occupied by control information of the synchronizing channel, the PBCH, the PDCCH, the PUCCH, and the like.

A total number N_{RE} of REs in the PDSCH is determined using the formula N_{RE}=min(156,N′_{RE})×n_{PRB}.

n_{PRB}=N₃=N₁−N₂. N₃ represents the number of target resource blocks, N₁ represents the number of first resource blocks, and N₂ represents the number of second resource blocks.

In some embodiments, the number of first resource blocks is a number of resource blocks in the configured PDSCH, and the number of second resource blocks is the sum of the number N_{UL} of resource blocks overlapped with the configured uplink resource part in the number of first resource blocks and the number N_{GUARD} of resource blocks overlapped with the guard sideband in the number of first resource blocks. That is, the number of second resource blocks is a sum of a number N_{UL} of resource blocks in the configured uplink resource part for transmitting the downlink data and a number N_{GUARD} of resource blocks in the guard sideband for transmitting the downlink data.

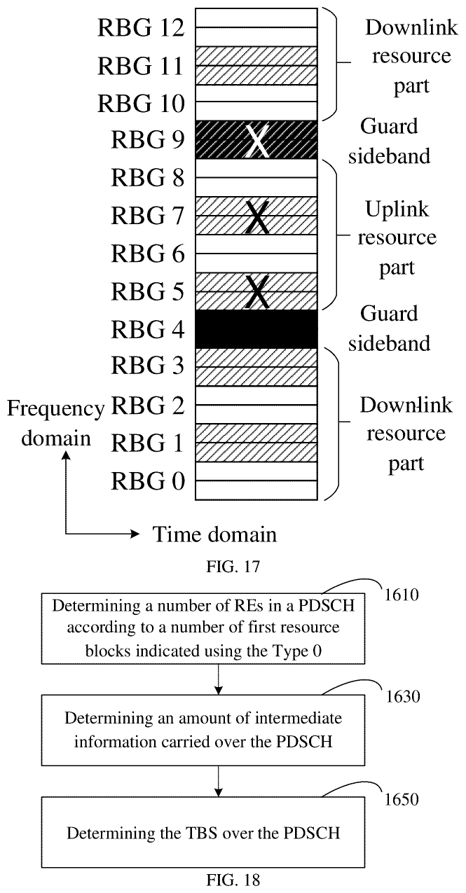

In some embodiments, as shown in FIG. 17, the terminal device 420 receives DCI for scheduling a PDSCH from the network device 410, which indicates that six RBGs are allocated to the PDSCH. The five RBGs are the RBG 1, the RBG 3, the RBG 5, the RBG 7, the RBG 9, and the RBG 11. Assuming that each RBG includes two PRBs, then N₁ is equal to 6 multiplied by 2, that is, 12. Two RBGs are in the uplink resource part, that is, the RBG 5 and the RBG 7, and one RBG is in the guard sideband, that is, the RBG 9. N_{UL}=2×2=4, N_{GUARD}=1×2=2, and N₂=N_{UL}+N_{GUARD}=4+2=6, and n_{PRB}=N₃=12−6−6.

In some embodiments, the data channel is the PUSCH, and the number of first resource blocks is the number of resource blocks in the PDSCH configured by the network device, and the number of second resource blocks is the sum of the number of resource blocks overlapped with the configured downlink resource part in the number of first resource blocks and the number of resource blocks overlapped with the guard sideband in the number of first resource blocks. That is, the number of second resource blocks is the sum of the number of resource blocks in the configured downlink resource part for transmitting the uplink data and the number of resource blocks in the guard sideband for transmitting the uplink data.

In S1430, an amount of intermediate information carried over the PDSCH is determined.

The amount N_{info} of intermediate information carried over the PDSCH is determined using the formular N_{info}=N_{RE}×R×Qₘ×ν. N_{RE} represents the calculated total number of REs in the PDSCH, R represents the bit rate of data transmission over the PDSCH, Qₘ represents the modulation order of data on the PDSCH, and ν represents the number of transmission layers of the PDSCH.

In S1450, the TBS over the PDSCH is determined.

The TBS over the PDSCH is determined based on the amount of intermediate information carried over the PDSCH.

The TBS is determined by quantitative table lookup in the case that N_{info} is less than or equal to 3824.

The TBS is determined by quantitative calculation in the case that N_{info} is greater than 3824.

In some embodiments, the TBS is determined by table lookup or calculation in the protocol in the 3GPP (for example, Section 5.1.3.2 of TS 38.214, version 17.2.0).

In summary, in the method according to the present disclosure, the TBS is determined based on the number of target resource blocks. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved. In addition, the number of second resource blocks is determined based on the uplink resource part and the guard sideband, such that the interference on the uplink transmission is reduced, and the complexity and cost of interference elimination are reduced.

FIG. 18 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S1610, a number of REs in a PDSCH is determined according to a number of first resource blocks indicated using the Type 0.

The number of REs in an RB is calculated using the formula N′_{RE}=N_{sc}^{RB}×N_{symb}^{sh}−N_{DMRS}^{PRB}−Nₒₕ^{PRB}. N_{sc}^{RB} is equal to 12, and represents the number of subcarriers in the RB, Nₛₕ^{symb} represents the number of symbols occupied by the PDSCH in the slot, N_{DMRS}^{PRB} represents the number of REs occupied by the DMRS in the PRB, and Nₒₕ^{PRB} represents the number of overhead REs configured in the PRB. The number of overhead REs includes the number of REs occupied by control information of the synchronizing channel, the PBCH, the PDCCH, the PUCCH, and the like.

A total number N_{RE} of REs in the PDSCH is determined using the formula N_{RE}=min(156,N′_{RE})×n_{PRB}.

n_{PRB}=N₃=N₁−N₂. N₃ represents the number of target resource blocks, N₁ represents the number of first resource blocks, and N₂ represents the number of second resource blocks.

In some embodiments, the number of first resource blocks is a number of resource blocks in the configured PDSCH, and the number of second resource blocks is the number of resource blocks overlapped with the configured uplink resource part in the number of first resource blocks. That is, the number of second resource blocks is a number of resource blocks in the configured uplink resource part for transmitting the downlink data. Alternatively, the number of second resource blocks is the sum of the number of resource blocks overlapped with the configured uplink resource part in the number of first resource blocks and the number of resource blocks overlapped with the guard sideband in the number of first resource blocks. That is, the number of second resource blocks is a sum of a number of resource blocks in the configured uplink resource part for transmitting the downlink data and a number of resource blocks in the guard sideband for transmitting the downlink data.

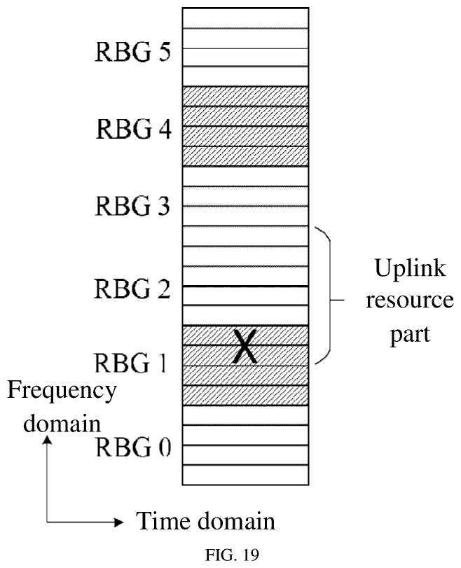

In some embodiments, as shown in FIG. 19, the terminal device 420 receives DCI for scheduling a PDSCH from the network device 410, and the network device indicates, using the Type 0, that two RBGs are allocated to the PDSCH. The two RBGs are the RBG 1 and the RBG 4, each RBG includes four RBs, then N₁ is equal to 2 multiplied by 4, that is, 8. Two PRBs are in the uplink resource part, that is, the N₂ is equal to 2, and then n_{PRB}=N₃=8−2=6. In the calculation mode, the number of second resource blocks is determined with RB-level granularity, such that the frequency domain resources are accurately managed, and the resource utilization is improved.

In some embodiments, the data channel is the PUSCH, and the number of first resource blocks is the number of resource blocks in the PDSCH configured by the network device, and the number of second resource blocks is the number of resource blocks overlapped with the configured downlink resource part in the number of first resource blocks. That is, the number of second resource blocks is the number of resource blocks in the configured downlink resource part for transmitting the uplink data.

In some embodiments, the data channel is a PUSCH, and the number of first resource blocks is the number of resource blocks in the PDSCH configured by the network device, and the number of second resource blocks is the sum of the number of resource blocks overlapped with the configured downlink resource part in the number of first resource blocks and the number of resource blocks overlapped with the guard sideband in the number of first resource blocks. That is, the number of second resource blocks is the sum of the number of resource blocks in the configured downlink resource part for transmitting the uplink data and the number of resource blocks in the guard sideband for transmitting the uplink data.

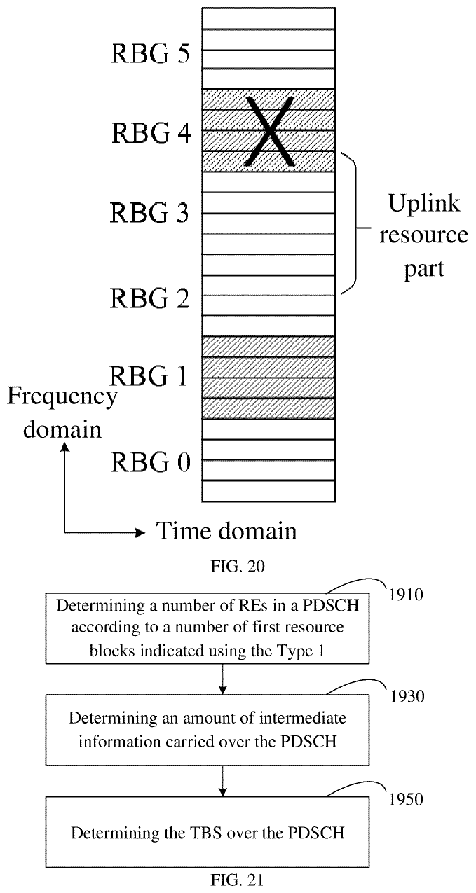

In some embodiments, the terminal device 420 receives DCI for scheduling a PDSCH from the network device 410, and the network device indicates, using the Type 0, that two RBGs are allocated to the PDSCH. The two RBGs are the RBG 1 and the RBG 4, and each of the RBGs includes four RBs, then N₁ is equal to 2 multiplied by 4, that is, 8. Part or all of an RB is in the uplink resource part. Assuming that one PRB in the RBG 1 is overlapped with the uplink resource part, then the number of second resource blocks is a number of PRBs overlapped with the uplink resource part. That is, N₂=1, and then n_{PRB}=N₃=8−1=7. Alternatively, as shown in FIG. 20, part or all of an RB is in the uplink resource part. Assuming that one PRB in the RBG 4 is overlapped with the uplink resource part, then the number of second resource blocks is a number of all PRBs in the RBG 4. That is, N₂=4, and then n_{PRB}=N₃=8−4=4. In the calculation mode, the number of second resource blocks is determined with RBG-level granularity, such that the frequency domain resources are simply and conveniently managed, and the simplicity of the resource management is improved.

In some embodiments, the data channel is a PUSCH, and the number of first resource blocks is the number of resource blocks in the PDSCH configured by the network device, and the number of second resource blocks is the number of resource blocks overlapped with the configured downlink resource part in the number of first resource blocks. That is, the number of second resource blocks is the number of resource blocks in the configured downlink resource part for transmitting the uplink data.

In some embodiments, the data channel is a PUSCH, and the number of first resource blocks is the number of resource blocks in the PDSCH configured by the network device, and the number of second resource blocks is the sum of the number of resource blocks overlapped with the configured downlink resource part in the number of first resource blocks and the number of resource blocks overlapped with the guard sideband in the number of first resource blocks. That is, the number of second resource blocks is the sum of the number of resource blocks in the configured downlink resource part for transmitting the uplink data and the number of resource blocks in the guard sideband for transmitting the uplink data.

In S1630, an amount of intermediate information carried over the PDSCH is determined.

The amount N_{info} of intermediate information carried over the PDSCH is determined by the formular: N_{info}=N_{RE}×R×Qₘ×ν. N_{RE} represents the calculated total number of REs in the PDSCH, R represents the bit rate of data transmission over the PDSCH, Qₘ represents the modulation order of data on the PDSCH, and ν represents the number of transmission layers of the PDSCH.

In S1650, the TBS over the PDSCH is determined.

The TBS over the PDSCH is determined based on the amount of intermediate information carried over the PDSCH.

The TBS is determined by quantitative table lookup in the case that N_{info} is less than or equal to 3824.

The TBS is determined by quantitative calculation in the case that N_{info} is greater than 3824.

In some embodiments, the TBS is determined by table lookup or calculation in the protocol in the 3GPP (for example, Section 5.1.3.2 of TS 38.214, version 17.2.0).

In summary, in the method according to the present disclosure, the TBS is determined based on the number of target resource blocks in the scenario where the frequency domain resource is indicated using the Type 0. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved. In addition, the number of second resource blocks is determined with RB-level granularity, such that the frequency domain resources are accurately managed, and the resource utilization is improved; and the number of second resource blocks is determined with RBG-level granularity, such that the frequency domain resources are simply and conveniently managed, and the simplicity of the resource management is improved.

FIG. 21 is a schematic flowchart of a method for determining a TBS according to some embodiments of the present disclosure. The method is illustrated using an example where the method is applicable to the network device 410, the terminal device 420, or the terminal device 430 shown in FIG. 4. The method includes at least part of the following processes.

In S1910, a number of REs in a PDSCH is determined according to a number of first resource blocks indicated using the Type 1.

The number of REs in an RB is calculated using the formula N′_{RE}=N_{sc}^{RB}×N_{symb}^{sh}−N_{DMRS}^{PRB}−Nₒₕ^{PRB}. N_{sc}^{RB} is equal to 12, and represents the number of subcarriers in the RB, N_{symb}^{sh} represents the number of symbols occupied by the PDSCH in the slot, N_{DMRS}^{PRB} represents the number of REs occupied by the DMRS in the PRB, and nₒₕ^{PRB} represents the number of overhead REs configured in the PRB. The number of overhead REs includes the number of REs occupied by control information of the synchronizing channel, the PBCH, the PDCCH, the PUCCH, and the like.

A total number N_{RE} of REs in the PDSCH is determined using the formula N_{RE}=min(156, N_{RE})×n_{PRB}.

n_{PRB}=N₃=N₁−N₂. N₃ represents the number of target resource blocks, N₁ represents the number of first resource blocks, and N₂ represents the number of second resource blocks.

In some embodiments, the number of first resource blocks is a number of resource blocks in the configured PDSCH, and the number of second resource blocks is the number of resource blocks overlapped with the configured uplink resource part in the number of first resource blocks. That is, the number of second resource blocks is a number of resource blocks in the configured uplink resource part for transmitting the downlink data. Alternatively, the number of second resource blocks is the sum of the number of resource blocks overlapped with the configured uplink resource part in the number of first resource blocks and the number of resource blocks overlapped with the guard sideband in the number of first resource blocks. That is, the number of second resource blocks is a sum of a number of resource blocks in the configured uplink resource part for transmitting the downlink data and a number of resource blocks in the guard sideband for transmitting the downlink data.

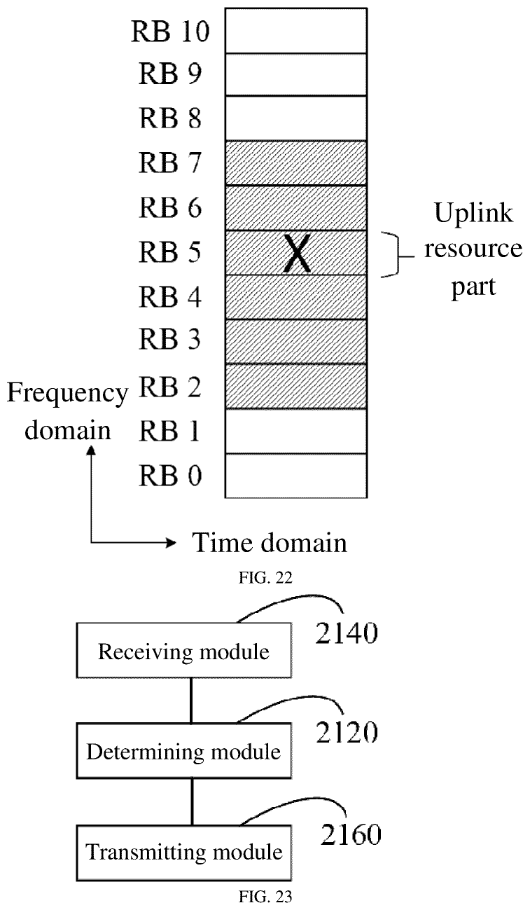

In some embodiments, as shown in FIG. 22, the terminal device 420 receives DCI for scheduling a PDSCH from the network device 410, and the network device indicates, using the Type 1, that RBs 2 to 7, that is, six RBs are allocated to the PDSCH. That is, N₁ is equal to 6. One PRB is in the uplink resource part, that is, the N₂ is equal to 1, and then n_{PRB}=N₃=6−1=5. In the calculation mode, the number of second resource blocks is determined with RB-level granularity, such that the frequency domain resources are accurately managed, and the resource utilization is improved.

In some embodiments, the data channel is the PUSCH, and the number of first resource blocks is the number of resource blocks in the PDSCH configured by the network device, and the number of second resource blocks is the number of resource blocks overlapped with the configured downlink resource part in the number of first resource blocks. That is, the number of second resource blocks is the number of resource blocks in the configured downlink resource part for transmitting the uplink data.

In some embodiments, the data channel is the PUSCH, and the number of first resource blocks is the number of resource blocks in the PDSCH configured by the network device, and the number of second resource blocks is the sum of the number of resource blocks overlapped with the configured downlink resource part in the number of first resource blocks and the number of resource blocks overlapped with the guard sideband in the number of first resource blocks. That is, the number of second resource blocks is the sum of the number of resource blocks in the configured downlink resource part for transmitting the uplink data and the number of resource blocks in the guard sideband for transmitting the uplink data.

In S1930, an amount of intermediate information carried over the PDSCH is determined.

The amount N_{info} of intermediate information carried over the PDSCH is determined by the formular: N_{info}=N_{RE}×R×Qₘ×ν. N_{RE} represents the calculated total number of REs in the PDSCH, R represents the bit rate of data transmission over the PDSCH, Qₘ represents the modulation order of data on the PDSCH, and ν represents the number of transmission layers of the PDSCH.

In S1950, the TBS over the PDSCH is determined.

The TBS over the PDSCH is determined based on the amount of intermediate information carried over the PDSCH.

The TBS is determined by quantitative table lookup in the case that N_{info} is less than or equal to 3824.

The TBS is determined by quantitative calculation in the case that N_{info} is greater than 3824.

In some embodiments, the TBS is determined by table lookup or calculation in the protocol in the 3GPP (for example, Section 5.1.3.2 of TS 38.214, version 17.2.0).

In summary, in the method according to the present disclosure, the TBS is determined based on the number of target resource blocks in the scenario where the frequency domain resource is indicated using the Type 1. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved. In addition, the number of second resource blocks is determined with RB-level granularity, such that the frequency domain resources are accurately managed, and the resource utilization is improved.

FIG. 23 is a block diagram of an apparatus for determining a TBS according to some embodiments of the present disclosure. The apparatus includes at least part of a determining module 2120, a receiving module 2140, or a transmitting module 2160.

The determining module 2120 is configured to determine the TBS based on a number of target resource blocks, wherein
the number of target resource blocks is determined based on a number of first resource blocks and a number of second resource blocks,
wherein the number of first resource blocks is a number of resource blocks configured for a data channel, and the number of second resource blocks includes a number of resource blocks belonging to a first frequency domain resource in the number of first resource blocks.

In some embodiments, a transmission direction of a frequency domain resource occupied by the data channel is different from a transmission direction of the first frequency domain resource.

In some embodiments, the determining module 2120 is configured to determine the number of target resource blocks based on a difference between the number of first resource blocks and the number of second resource blocks.

In some embodiments, the determining module 2120 is configured to determine the number of target resource blocks based on the number of first resource blocks and the number of second resource blocks in a first transmission in the repetitive transmissions.

In some embodiments, the determining module 2120 is configured to determine the number of target resource blocks based on a difference between the number of first resource blocks and the number of second resource blocks in the first transmission in the repetitive transmissions.

In some embodiments, the determining module 2120 is configured to determine the number of target resource blocks based on the number of first resource blocks and the number of second resource blocks in at least two transmissions in the repetitive transmissions.

In some embodiments, the determining module 2120 is configured to determine at least two numbers of third resource blocks based on the number of first resource blocks and the number of second resource blocks in at least two transmissions in the repetitive transmissions, and determine the number of target resource blocks based on a minimum value, a maximum value, an average value, or a middle value of the at least two numbers of third resource blocks.

In some embodiments, the data channel is a downlink data channel, and the number of second resource blocks includes a number of resource blocks belonging to an uplink transmission resource in the number of first resource blocks or a number of resource blocks belonging to an uplink transmission resource or a guard sideband in the number of first resource blocks.

In some embodiments, the data channel is an uplink data channel, and the number of second resource blocks includes a number of resource blocks belonging to a downlink transmission resource in the number of first resource blocks or a number of resource blocks belonging to a downlink transmission resource or a guard sideband in the number of first resource blocks.

In some embodiments, the data channel is a first sidelink channel, and the number of second resource blocks includes a number of resource blocks belonging to a first type resource in the number of first resource blocks or a number of resource blocks belonging to a first type resource or a guard sideband in the number of first resource blocks, wherein the first type resource includes at least one of a second sidelink transmission resource, an uplink transmission resource, or a downlink transmission resource, wherein a transmission direction of the second sidelink transmission resource is different from a transmission direction of a first sidelink transmission resource, the first sidelink transmission resource being a sidelink resource corresponding to the first sidelink channel.

In some embodiments, the number of first resource blocks is the number of resource blocks dynamically or semi-persistently configured for the data channel.

In some embodiments, the apparatus includes: a receiving module 2140, configured to receive configuration of the number of first resource blocks.

In some embodiments, the apparatus includes: a receiving module 2140, configured to receive dynamic or semi-persistent configuration of the number of first resource blocks.

In some embodiments, the apparatus includes: a transmitting module 2160, configured to transmit configuration of the number of first resource blocks.

In some embodiments, the apparatus includes: a transmitting module 2160, configured to transmit dynamic or semi-persistent configuration of the number of first resource blocks.

In some embodiments, the first frequency domain resource is configured by a network device.

In some embodiments, the apparatus includes: a receiving module 2140, configured to receive configuration of the first frequency domain resource.

In some embodiments, the apparatus includes: a transmitting module 2160, configured to transmit configuration of the first frequency domain resource.

In some embodiments, the guard sideband is configured by a network device, determined based on a capability of a terminal device, or configured by a network device based on a report capability of a terminal device.

In some embodiments, the apparatus includes: a receiving module 2140, configured to receive configuration of the guard sideband.

In some embodiments, the apparatus includes: a transmitting module 2160, configured to transmit configuration of the guard sideband.

In some embodiments, the apparatus includes: a receiving module 2140, configured to receive the report capability of the terminal device.

In some embodiments, the apparatus includes: a transmitting module 2160, configured to transmit configuration of the guard sideband based on the report capability of the terminal device.

In some embodiments, the apparatus includes the receiving module 2160, configured to report the capability.

In some embodiments, the determining module 2120 is configured to determine the guard sideband based on the capability of the terminal device.

In some embodiments, a frequency domain resource in a time domain unit of the data channel includes at least one resource part for the data channel and at least one resource part belonging to the first frequency domain resource.

In some embodiments, the frequency domain resource in the time domain unit of the data channel includes one resource part for the data channel and one resource part belonging to the first frequency domain resource, or two resource parts for the data channel and one resource part belonging to the first frequency domain resource.

In some embodiments, the determining module 2120 is configured to: determine a number of REs in the data channel based on the number of target resource blocks; and determine the TBS based on at least one of a modulation mode of the data channel, a number of transmission layers of the data channel, a bit rate of the data channel, or the number of REs in the data channel.

In some embodiments, a frequency domain resource corresponding to a TB is determined based on at least one of dynamic scheduling or semi-persistent scheduling.

In some embodiments, the method is applicable to at least one of a first frequency domain resource indication type or a second frequency domain resource indication type, wherein the first frequency domain resource indication type indicates a frequency domain resource corresponding to a TB by a bitmap, and the second frequency domain resource indication type indicates the frequency domain resource corresponding to the TB by a start serial number of the resource block and a continuous length of the resource block.

In some embodiments, the apparatus includes: a receiving module 2140, configured to receive configuration of the guard sideband.

In some embodiments, the apparatus includes: a transmitting module 2160, configured to transmit configuration of the guard sideband.

In summary, in the apparatus according to the present disclosure, the TBS is determined based on the number of target resource blocks. As the number of target resource blocks determined based on the number of first resource blocks and the number of second resource blocks is closer to the number of target resource blocks actually used in the data transmission, the TBS is closer to the TBS actually used in the data transmission, the configured bit rate is closer to the actual bit rate, and the reliability of data transmission is improved.

It should be noted that for the apparatus according to the above embodiments, the division of the functional modules is merely exemplary. In practical application, the above functions may be assigned to different functional modules according to actual needs. That is, the internal structure of the device may be divided into different functional modules to implement all or a part of the above functions.

With regard to the apparatus in the above embodiments, the specific manner in which each module performs the operation has been described in detail in the embodiments related to the method and will not be described in detail herein.

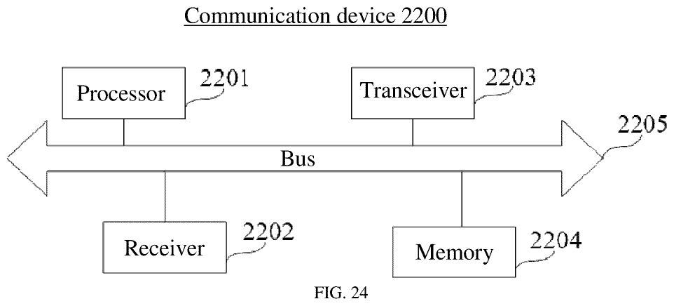

FIG. 24 is a schematic structural diagram of a communication device (a terminal device or a network device) according to some embodiments of the present disclosure. The communication device 2200 includes: a processor 2201, a receiver 2202, a transmitter 2203, a memory 2204, and a bus 2205.

The processor 2201 includes one or more processing cores, and achieves various functional applications and information processing by running software programs and modules. In some embodiments, the processor 2201 is configured to achieve the function and processes of the above determining module 2120.

The receiver 2202 and the transmitter 2203 are practiced as a communication assembly. The communication assembly is a communication chip. In some embodiments, the receiver 2202 is configured to achieve the function and processes of the above receiving module 2140. In some embodiments, the transmitter 2203 is configured to achieve the function and processes of the above transmitting module 2160.

The memory 2204 is connected to the processor 2201 over the bus 2205. The memory 2204 is configured to store one or more instructions, and the processor 2201, when loading and executing the one or more instructions, is caused to perform various processes in the above method embodiments.

In addition, the memory 2204 is practiced by any type of volatile or non-volatile storage device or combinations thereof. The volatile or non-volatile storage device includes but is not limited to a disk or optical disc, an electrically erasable programmable read-only memory (EEPROM), an erasable programmable read-only memory (EPROM), a persistent random-access memory (SRAM), a read-only memory (ROM), a magnetic memory, a flash memory, or a programmable read-only memory (PROM).

In some embodiments, the receiver 2202 receives signal/data independently, the processor 2201 controls the receiver 2202 to receive signal/data, the processor 2201 requests the receiver 2202 to receive signal/data, or, the processor 2201 cooperates with the receiver 2202 to receive signal/data.

In some embodiments, the transmitter 2203 transmits signal/data independently, the processor 2201 controls the transmitter 2203 to transmit signal/data, the processor 2201 requests the transmitter 2203 to transmit signal/data, or, the processor 2201 cooperates with the transmitter 2203 to transmit signal/data.

Some embodiments of the present disclosure further provide a computer-readable storage medium storing one or more programs, wherein the one or more programs, when loaded and run by a processor, cause the processor to perform the method for determining the TBS in the above method embodiments.

Some embodiments of the present disclosure further provide a chip. The chip includes programmable logic circuitry and/or program instructions, wherein the chip, when running, is caused to perform the method for determining the TBS in the above method embodiments.

Some embodiments of the present disclosure further provide a computer program product. The computer program product, when running on a processor of a computer device, causes the computer device to perform the method for determining the TBS in the above method embodiments.

Some embodiments of the present disclosure further provide a computer program. The computer program includes one or more computer instructions, wherein the one or more computer instructions, when loaded and run on a processor of a computer device, cause the computer device to perform the method for determining the TBS in the above method embodiments.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for determining a transport block size, applicable to a network device, a terminal device, or a network device and a terminal device, the method comprising:
determining the transport block size based on a number of target resource blocks, wherein the number of target resource blocks is determined based on a number of first resource blocks and a number of second resource blocks, wherein the number of first resource blocks is a number of resource blocks configured for a data channel, and the number of second resource blocks comprises a number of resource blocks belonging to a first frequency domain resource in the number of first resource blocks.

2. The method according to claim 1, wherein a transmission direction of a frequency domain resource occupied by the data channel is different from a transmission direction of the first frequency domain resource.

3. The method according to claim 1, wherein the number of target resource blocks is determined based on a difference between the number of first resource blocks and the number of second resource blocks.

4. The method according to claim 1, wherein a transport block is subjected to repetitive transmissions, and the number of target resource blocks is determined based on the number of first resource blocks and the number of second resource blocks in at least two transmissions in the repetitive transmissions.

5. The method according to claim 4, wherein the number of target resource blocks is a minimum value, a maximum value, an average value, or a middle value of at least two numbers of third resource blocks, wherein the at least two numbers of third resource blocks are determined based on the numbers of first resource blocks and the number of second resource blocks in at least two transmissions in the repetitive transmissions.

6. The method according to claim 1, wherein the data channel is a downlink data channel, and the number of second resource blocks comprises a number of resource blocks belonging to an uplink transmission resource in the number of first resource blocks or a number of resource blocks belonging to an uplink transmission resource or a guard sideband in the number of first resource blocks.

7. The method according to claim 1, wherein the data channel is an uplink data channel, and the number of second resource blocks comprises a number of resource blocks belonging to a downlink transmission resource in the number of first resource blocks or a number of resource blocks belonging to a downlink transmission resource or a guard sideband in the number of first resource blocks.

8. The method according to claim 1, wherein the number of first resource blocks is the number of resource blocks dynamically or semi-persistently configured for the data channel.

9. The method according to claim 6, wherein the guard sideband is configured by a network device, determined based on a capability of a terminal device, or configured by a network device based on a report capability of a terminal device.

10. The method according to claim 1, wherein a frequency domain resource in a time domain unit of the data channel comprises at least one resource part for the data channel and at least one resource part belonging to the first frequency domain resource.

11. The method according to claim 10, wherein the frequency domain resource in the time domain unit of the data channel comprises one resource part for the data channel and one resource part belonging to the first frequency domain resource, or two resource parts for the data channel and one resource part belonging to the first frequency domain resource.

12. The method according to claim 1, wherein determining the transport block size based on the number of target resource blocks comprises:
determining a number of resource elements in the data channel based on the number of target resource blocks; and
determining the transport block size based on at least one of a modulation mode of the data channel, a number of transmission layers of the data channel, a bit rate of the data channel, or the number of resource elements in the data channel.

13. The method according to claim 1, wherein a frequency domain resource corresponding to a transport block is determined based on at least one of dynamic scheduling or semi-persistent scheduling.

14. The method according to claim 1, wherein the method is applicable to at least one of a first frequency domain resource indication type or a second frequency domain resource indication type, wherein the first frequency domain resource indication type indicates a frequency domain resource corresponding to a transport block by a bitmap, and the second frequency domain resource indication type indicates the frequency domain resource corresponding to the transport block by a start serial number of the resource block and a continuous length of the resource block.

15. A terminal device, comprising: a processor, a transceiver connected to the processor, and a memory storing one or more executable instructions; wherein the processor, when loading and executing the one or more executable instructions, is caused to:
determine the transport block size based on a number of target resource blocks, wherein the number of target resource blocks is determined based on a number of first resource blocks and a number of second resource blocks, wherein the number of first resource blocks is a number of resource blocks configured for a data channel, and the number of second resource blocks comprises a number of resource blocks belonging to a first frequency domain resource in the number of first resource blocks.

16. The terminal device according to claim 15, wherein a transmission direction of a frequency domain resource occupied by the data channel is different from a transmission direction of the first frequency domain resource.

17. The terminal device according to claim 15, wherein the number of target resource blocks is determined based on a difference between the number of first resource blocks and the number of second resource blocks.

18. A network device, comprising: a processor, a transceiver connected to the processor, and a memory storing one or more executable instructions; wherein the processor, when loading and executing the one or more executable instructions, is caused to:
determine the transport block size based on a number of target resource blocks, wherein the number of target resource blocks is determined based on a number of first resource blocks and a number of second resource blocks, wherein the number of first resource blocks is a number of resource blocks configured for a data channel, and the number of second resource blocks comprises a number of resource blocks belonging to a first frequency domain resource in the number of first resource blocks.

19. The network device according to claim 18, wherein a frequency domain resource in a time domain unit of the data channel comprises at least one resource part for the data channel and at least one resource part belonging to the first frequency domain resource.

20. The network device according to claim 18, wherein the processor, when loading and executing the one or more executable instructions, is further caused to:
determine a number of resource elements in the data channel based on the number of target resource blocks; and
determine the transport block size based on at least one of a modulation mode of the data channel, a number of transmission layers of the data channel, a bit rate of the data channel, or the number of resource elements in the data channel.
